(19) United States
(12) Patent Application Publication
(10) Pub. No.: US 2020/0385194 A1
(43) Pub. Date: Dec. 10, 2020

(54) CLOSABLE COOKING POUCH

(71) Applicant: Cookina Holdings Inc., Brossard (CA)

(72) Inventor: Alain Richard, Brossard (CA)

(21) Appl. No.: 16/817,595

(22) Filed: Mar. 12, 2020

Related U.S. Application Data
(63) Continuation of application No. 15/257,813, filed on Sep. 6, 2016, now abandoned.

(51) Int. Cl. B65D 81/34; B65D 33/24; A23L 5/10

(52) U.S. Cl. CPC B65D 81/3438; B65D 33/24; B65D 81/3461; A47J 2027/043; A23L 5/13; A23V 2002/00; B65D 81/343

(57) ABSTRACT

A closable cooking pouch includes a heat resistant pouch body with a flap attached to it. The flap is tuckable into an opening the permits access to the pouch's interior. To close the pouch, the flap is tucked into the pouch's interior and a hook portion that forms part of the flap is inserted through a slot on the pouch body. Once through the slot, the hook portion retains at least a portion of the flap in the slot when the pouch is closed and typically provides sufficient retaining force to keep the pouch closed if it is flipped while being used for cooking. The pouch may be manufactured from a single sheet of material.

### CROSS-REFERENCE TO RELATED APPLICATION

This application is a continuation of U.S. patent application Ser. No. 15/257,813 filed Sep. 6, 2016, the contents of which is incorporated herein by reference in its entirety.

### TECHNICAL FIELD

The present disclosure is directed at a closable cooking pouch.

### BACKGROUND

Health conscious cooking is becoming increasingly popular. One way in which consumers practice health conscious cooking is to reduce the amount of fat used during cooking. Using non-stick cooking surfaces and cooking with steam are two ways in which consumers can reduce the amount of butter and oil used during cooking.

### SUMMARY

According to a first aspect, there is provided a closable cooking pouch. The pouch comprises a heat resistant pouch body comprising an opening and a slot; and a flap attached to the pouch body and tuckable into the opening to close the pouch. The flap comprises a hook portion that is insertable through the slot and that is shaped to retain at least a portion of the flap in the slot when the flap is through the slot and the hook portion is outside the pouch.

The pouch body and flap may be manufactured using identical material.

The pouch body and flap may comprise polytetrafluoroethylene and exclude perfluorooctanoic acid.

The hook portion may be elastically deformable.

The hook portion may be planar.

The hook portion may comprise a trapezoid, and the trapezoid may have rounded vertices. The trapezoid may be an isosceles trapezoid.

A longer base of the trapezoid may be nearer to the opening when the pouch is open than a shorter base of the trapezoid. The longer base of the trapezoid may be longer than the slot. The shorter base of the trapezoid may be shorter than the slot.

A portion of the opening uncovered by the flap when the pouch is closed may comprise a steam vent that permits steam to escape the interior of the pouch.

According to another aspect, there is provided a closable cooking pouch that comprises a heat resistant pouch body manufactured using a material comprising polytetrafluoroethylene, with the heat resistant pouch body comprising a slot located in a face of the pouch body and an opening along one side of the pouch body; and a flap attached to the pouch body and tuckable into the opening to close the pouch. The flap may comprise an elastically deformable hook portion that is insertable through the slot from the interior of the pouch and that comprises an isosceles trapezoid having a longer base located nearer to where the flap is attached to the pouch body than a shorter base of the trapezoid. The longer base of the trapezoid may be longer than the slot and the shorter base of the trapezoid is shorter than the slot.

According to another aspect, there is provided a method for using the closable cooking pouch of any of the foregoing aspects and suitable combinations thereof. The method comprises tucking the flap into the pouch through the opening; and inserting the hook portion through the slot from the interior of the pouch.

Inserting the hook portion through the slot may comprise grasping the hook portion through the slot and then pulling the hook portion through the slot.

The method may further comprise putting food into the pouch prior to tucking the flap into the pouch; after inserting the hook portion through the slot, cooking the food while the food is inside the pouch; and flipping the pouch while the food is cooking, wherein the pouch remains closed during flipping.

According to another aspect, there is provided a method for manufacturing the closable cooking pouch of any of the foregoing aspects and suitable combinations thereof. The method comprises cutting, from a single sheet of material, a strip of material that delineates a front side of the pouch body, a rear side of the pouch body, the flap, and the slot; folding the strip such that the front and rear sides oppose each other; and sealing a portion of the peripheries of the front and rear sides to each other. An unsealed portion of the peripheries is coverable by the flap and comprises the opening of the pouch.

Sealing the portion of the peripheries may comprise heat fusing the portion of the peripheries together.

The pouch body may be polygonal, and the opening may extend along one edge of the pouch body. For example, the pouch body may be rectangular and the opening may comprise one of the shorter edges of the pouch body.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIGS. 1A and 1B are front perspective views of a closable cooking pouch when opened and when closed, respectively, according to a first embodiment.

FIG. 2 is a front elevation view of a sheet of cut, non-stick material used to manufacture the first embodiment of the cooking pouch.

FIGS. 3A and 3B are front and rear elevation views, respectively, of the first embodiment of the cooking pouch when opened.

FIG. 4 is a front elevation view of the first embodiment of the cooking pouch when closed.

FIGS. 5A and 5B are sectional views of the first embodiment of the cooking pouch taken along lines 5A-5A of FIG. 3A and 5B-5B of FIG. 4, respectively.

FIG. 6 is a top plan view of the first embodiment of the cooking pouch when closed.

FIG. 7 is a method for making a closable cooking pouch, according to another embodiment.

FIG. 8 is a method for using a closable cooking pouch, according to another embodiment.

### DETAILED DESCRIPTION

The embodiments described herein are directed at a closable cooking pouch that is usable during cooking to at least partially cook the food contained within the pouch using steam. In certain embodiments, the pouch is manufactured using a non-stick material, which facilitates usage on cooking surfaces such as stainless steel and cast iron. The pouch comprises a flap that can be folded or bent to close the pouch and a hook portion that can be inserted through a slot in the pouch body to secure the flap in place when the pouch is closed. To close the pouch, the flap is tucked into the pouch's interior and the hook portion is inserted through the slot. The hook portion is shaped to retain at least a portion of the flap in the slot when the flap is through the slot and the hook portion is outside the pouch. The pouch may accordingly be used to flip food during cooking without inadvertently opening, which releases heat and thereby lengthens cooking times, and which may cause the food to spill. As used in this disclosure, “cooking” refers to multiple manners of cooking, such as grilling using a barbecue or cooking using appliances such as ovens, microwaves, stovetops, and sandwich grills.

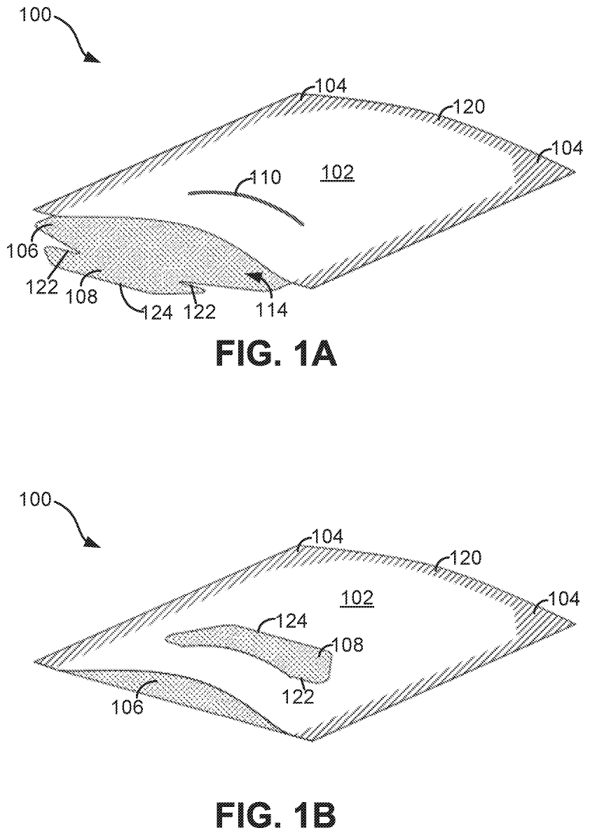

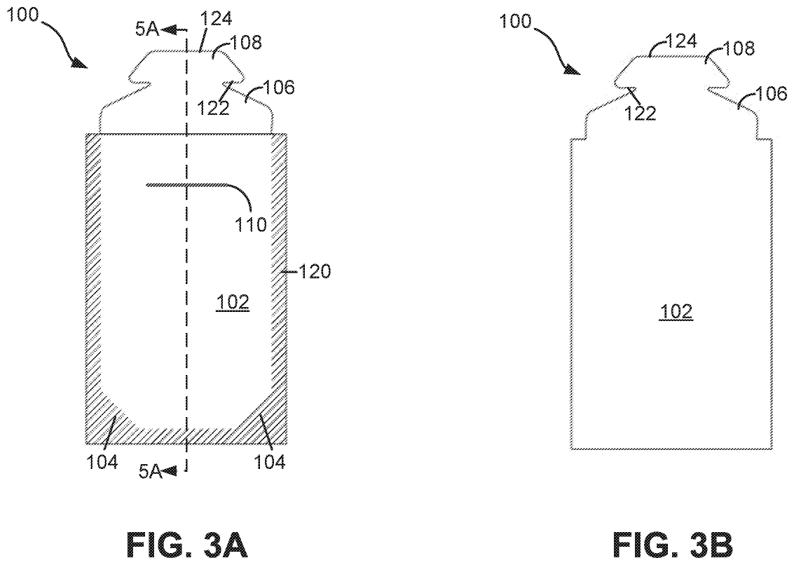

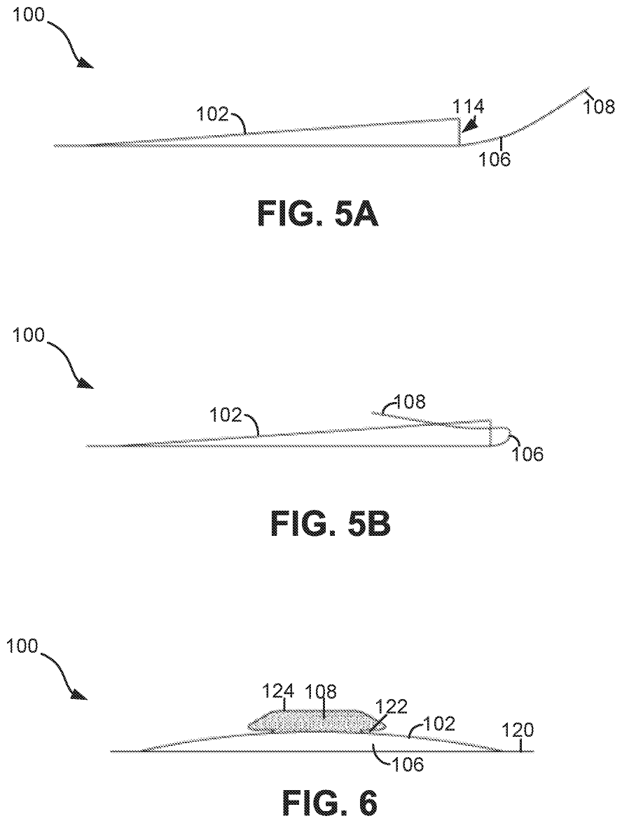

A closable cooking pouch 100 according to a first embodiment is depicted in the figures. More specifically, FIGS. 1A and 1B are front perspective views of the pouch 100 when opened and when closed, respectively; FIGS. 3A and 3B are front and rear elevation views, respectively, of the pouch 100 when opened; FIG. 4 is a front elevation view of the pouch 100 when closed; FIGS. 5A and 5B are sectional views of the pouch 100 taken along lines 5A-5A of FIG. 3A and 5B-5B of FIG. 4, respectively; and FIG. 6 is a top plan view of the pouch 100 when closed.

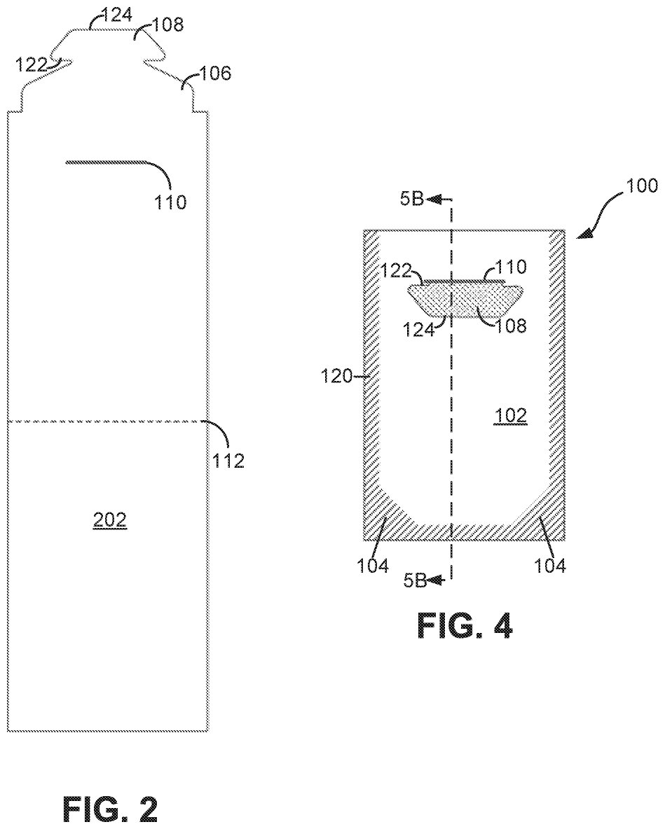

The pouch 100 comprises a pouch body 102 that comprises a front side and a rear side. The front and rear sides are sealed to each other along the periphery of the left, bottom, and right edges of the pouch 100 using heat fusion, as described in more detail with respect to FIG. 2, below. The pouch 100 comprises an opening 114 permitting access to the pouch's 100 interior along the front side's top edge and a slot 110 on its front side. A flap 106 extends upwardly from the pouch's 100 rear side and comprises a hook portion 108 at its end. In the first embodiment of the pouch 100, the hook portion 108 comprises a trapezoid that has rounded vertices and that has a longer base 122 and a shorter base 124, with the longer base 122 being nearer to the opening 114 than the shorter base 124. The portion of the flap 106 immediately below the hook portion 108 is shorter than the longer base 122. In the depicted embodiment, the longer base 122 is longer than the slot 110, the shorter base 124 is shorter than the slot 110, and the trapezoid is an isosceles trapezoid. The hook portion 108 is thereby shaped to retain at least a portion of the flap 106 in the slot 110 when the flap 106 is through the slot 110 and the hook portion 108 is outside the pouch 100.

The pouch 100 as shown for the first embodiment when opened is shown as slightly inflated. This may occur, for example, when air is blown into the pouch 100 through the opening 114. As discussed in further detail below in respect of FIG. 2, the pouch 100 as manufactured permits the front and rear sides to rest flush against each other.

The first embodiment of the pouch 100 is manufactured using a non-stick and heat resistant material. In respect of the first embodiment, by “heat resistant” it is meant that the pouch 100 can be heated to approximately 550° F. (288° C.) without combusting, melting, or evaporating. However, in different embodiments (not depicted) the pouch 100 may be manufactured from a heat resistant material that combusts, melts, or evaporates at a different temperature. One example type of material that may be used to manufacture the pouch 100 is the material used to manufacture the non-stick and reusable barbecue grilling sheets sold by COOKINA® Inc. of Brossard, Québec, Canada. Another example type of material is the Parchminium™ reusable presentation and cooking sheet, also sold by COOKINA® Inc.

As mentioned above, the pouch 100 is shown in FIGS. 1A, 3A, 3B, and 5A as being open. To close the pouch 100 so that it appears as depicted in FIGS. 4, 5B, and 6, a consumer takes the flap 106, tucks it into the pouch's 100 interior via the opening 114, and then inserts the hook portion 108 out through the slot 110. FIG. 5A in particular shows a sectional view of the pouch 100 when it is opened, and FIG. 5B shows the analogous sectional view of the pouch 100 when it is closed. FIG. 6 shows a top plan view of the pouch 100 when it is closed, highlighting the fact that the hook portion 108 is protruding out through the slot 110 and on to the pouch's 100 front side.

The hook portion 108 is shaped to catch on to the front side of the pouch 100 as the flap 106 is being pulled out of the pouch 100, thereby resisting movement and helping to keep the flap 106 in place and the pouch 100 closed. In the first embodiment, the hook portion 108 comprises the trapezoid having the shorter base 124 and the longer base 122, with the shorter base 124 being shorter than the length of the slot 110 and the longer base 122 being longer than the length of the slot 110. When closing the pouch 100, the fact that the shorter base 124 is shorter than the slot 110 helps the consumer initially insert the hook portion 108 through the slot 110. Once the hook portion 108 has been entirely inserted through the slot 110, the fact that the longer base 122 is longer than the slot 110 means that the trapezoid catches on the pouch's 100 front side as the hook portion 108 is removed, thereby resisting that removal. The material used to manufacture the first embodiment of the pouch 100 is elastically deformable such that with sufficient force, one or both of the trapezoid and the slot 110 deforms as a result of the trapezoid being pressed against the pouch's 100 front side, manual manipulation from the consumer, or both. This deformation permits the hook portion 108 to be pulled back into the pouch's 100 interior and the pouch 100 to be opened. Once the force that causes the deformation is removed, one or both of the hook portion 108 and the slot 110 returns substantially to its original shape, thereby permitting the pouch 100 to be subsequently closed again.

While in the first embodiment the hook portion 108 is a trapezoid, in different embodiments (not depicted) different shapes of the hook portion 108 are possible. For example, the hook portion 108 may be triangular, square, or arcuate. Furthermore, while the hook portion 108 is planar in the first embodiment, in different embodiments the hook portion 108 may be non-planar. For example, the hook portion 108 may be spherical or hemispherical and have a substantial thickness that helps to retain the flap 106 in place.

Inserting the hook portion 108 through the slot 110 from the pouch's 100 interior is useful when cooking for at least two reasons. One, as the hook portion 108 rests on the exterior of the pouch 100, it remains cleaner than it would if it were resting within the pouch 100 and directly contacting the food. This can be useful given that the consumer may manually grab the hook portion 108 to pull it through the slot 110 when opening and closing the pouch 100. Two, steam generated during cooking does not envelop the hook portion 108 as it would if the hook portion 108 were inside the pouch 100, again facilitating the consumer's manually grabbing the hook portion 108. Through experiment, it has been found that when manufactured using non-stick barbecue grilling sheets or the Parchminium™ presentation and cooking sheets, both sold by COOKINA® Inc., the hook portion 108 provides a sufficient retaining force to permit the consumer during cooking to flip the pouch 100 when closed and containing food without the pouch 100 inadvertently opening, while still permitting the consumer to open and close the pouch 100 in a straightforward manner.

Referring now to FIG. 2, there is shown a strip 202 of material from which the pouch 100 is manufactured. The strip 202 of FIG. 2 consists of a single type of material and is cut from a larger sheet (not shown) of that material. As noted above, the strip 202 may comprise a non-stick barbecue grilling sheet or Parchminium™ presentation and cooking sheet sold by COOKINA® Inc.; alternatively, the strip 202 may comprise a different type of non-stick sheet sold by COOKINA® Inc. More generally, the strip 202 may comprise any suitable heat resistant sheet that comprises a fluoropolymer that coats and encapsulates a fabric mesh, resulting in a resilient and flexible sheet. In certain embodiments, the fluoropolymer may comprise polytetrafluoroethylene (“PTFE”) and, in a subset of those embodiments, also exclude perfluorooctanoic acid (“PFOA”).

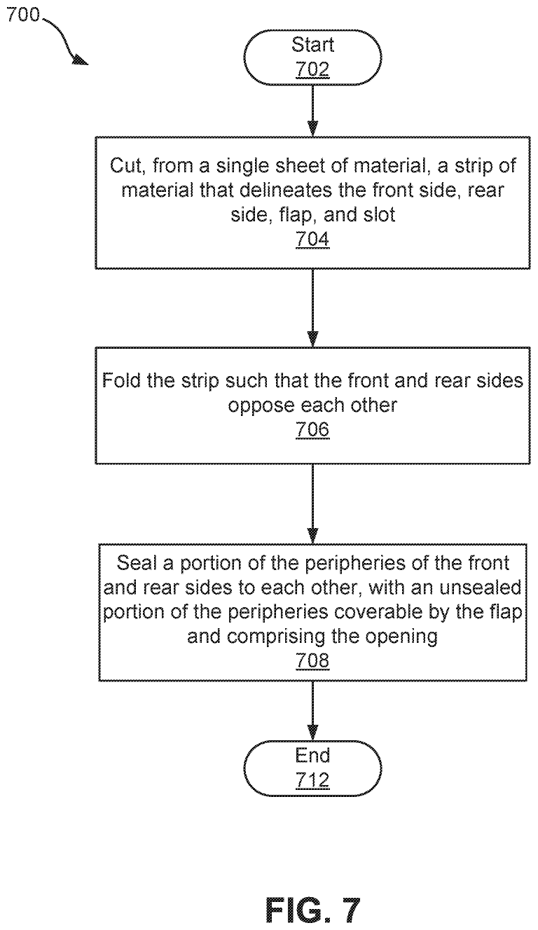

FIG. 7 depicts a method 700 for making the pouch 100, according to another embodiment. A manufacturer begins performing the method 700 at block 702 and proceeds to block 704 where the manufacturer cuts, from a single sheet of material, the strip 202. The strip 202 is cut so that the front and rear sides of the pouch body 102, the slot 110, and the flap 106 (including the hook portion 108) are delineated, as shown in FIG. 2. The manufacturer proceeds to block 706, where he or she folds the strip 202 along a line 112 so that the front and rear sides oppose each other. At block 708, the manufacturer seals a portion of the peripheries of the front and rear sides to each other, with an unsealed portion of the peripheries coverable by the flap 106 and comprising the opening 114. In the first embodiment of the pouch 100, the manufacturer heat fuses the left, bottom, and right edges of the pouch body 102 to form a sealed periphery 120. Following sealing, the method 700 ends at block 712.

In the first embodiment of the pouch 100, the bottom left and right corners 104 of the sealed periphery 120 are triangular in shape to facilitate cleaning of the pouch's 100 interior and to increase the area of the sealed periphery 120, thereby also increasing the pouch's 100 integrity. In different embodiments (not depicted), the corners 104 may be shaped differently than as depicted. For example, the corners 104 may be perpendicular (i.e., a portion of the sealed periphery 120 extending along the pouch's 100 left and right edges may intersect perpendicularly with a portion of the sealed periphery 120 extending along the pouch's 100 bottom edge) or may be filled, but not triangular in shape (e.g., the corners 104 may be rounded). In different embodiments (not depicted), the periphery 120 may be sealed using a different technique, such as ultrasonic welding or a heat resistant adhesive.

While in the first embodiment of the pouch 100 the pouch body 102 is rectangular with the opening 114 comprising one of the body's 102 shorter edges, in different embodiments (not depicted) the pouch body 102 may be differently shaped. For example, in certain embodiments the pouch body 102 may be polygonal, and the opening 114 may be along one edge of the polygonal pouch body 102 with the remaining edges comprising the sealed periphery 120.

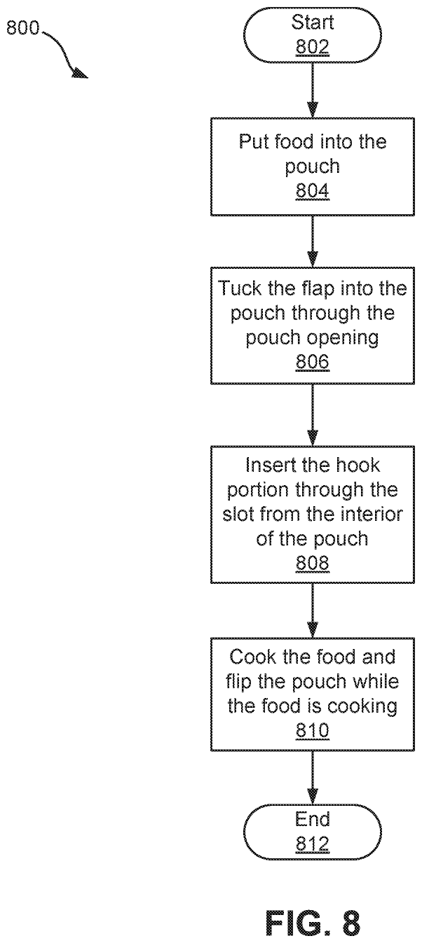

Referring now to FIG. 8, there is shown a method 800 for using the pouch 100, according to another embodiment. The consumer begins performing the method 800 at block 802 and proceeds to block 804 where the consumer puts food in the pouch via the opening 114 while the pouch 100 is opened. The consumer proceeds to block 806 where he or she tucks the flap 106 into the pouch 100 through the opening 114, following which he or she inserts the hook portion 108 through the slot 110 from the pouch's 100 interior at block 808. As mentioned above, this secures the pouch 100 closed. The consumer may insert the hook portion 108 through the slot 110 by grasping the hook portion 108 through the slot 110 from the outside of the pouch 100 and then pulling the hook portion 108 through the slot. The consumer then proceeds to block 810 where he or she cooks the food on, for example, a barbecue and flips the pouch 100 while the food is cooking. The consumer may additionally or alternatively cook the food using a microwave or oven and similarly flip the pouch 100 during cooking (and in the case of the microwave, while the microwave is paused). The pouch 100 remains closed due to the combination of the slot 110, flap 106, and hook portion 108. The method 800 ends at block 812.

When closed, the portion of the opening 114 that is uncovered by the flap 106 acts as a steam vent that permits steam to escape from the pouch 100, thereby preventing expansion and potential bursting of the pouch 100. Any steam escapes at a slow enough rate that it helps to cook the food in the pouch 100 prior to escaping.

Directional terms such as “top”, “bottom”, “upwards”, “downwards”, “vertically”, and “laterally” are used in this disclosure for the purpose of providing relative reference only, and are not intended to suggest any limitations on how any article is to be positioned during use, or to be mounted in an assembly or relative to an environment. The term “couple” and variants of it such as “coupled”, “couples”, and “coupling” as used in this disclosure are intended to include indirect and direct connections unless otherwise indicated. For example, if a first article is coupled to a second article, that coupling may be through a direct connection or through an indirect connection via another article. Additionally, the singular forms “a”, “an”, and “the” as used in this disclosure are intended to include the plural forms as well, unless the context clearly indicates otherwise.

The word “approximately” as used in this description in conjunction with a number means within 10% of that number.

FIGS. 7 and 8 are flowcharts of example methods. Some of the blocks illustrated in the flowcharts may be performed in an order other than that which is described. Also, it should be appreciated that not all of the blocks described in the flowcharts are required to be performed, that additional blocks may be added, and that some of the illustrated blocks may be substituted with other blocks.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A closable cooking pouch, the pouch comprising:
(a) a heat resistant pouch body comprising at least one heat fusion-sealed edge defining an opening in the pouch body, the pouch body further comprising a slot; and
(b) a flap attached to the pouch body and tuckable into the opening to close the pouch, wherein the flap comprises a hook portion that is insertable through the slot and that is shaped to retain at least a portion of the flap in the slot when the flap is through the slot and the hook portion is outside the pouch, wherein the flap comprises a flap portion connecting the pouch body to the hook portion, wherein the flap portion comprises a pair of angled linear edges, wherein the hook portion comprises a pair of lower edges each being parallel to the slot, and wherein each lower edge forms a notch with a respective one of the angled linear edges.

2. The pouch of claim 1 wherein the pouch body and flap are manufactured using identical material.

3. The pouch of claim 1 wherein the pouch body and flap comprise polytetrafluoroethylene and exclude perfluorooctanoic acid.

4. The pouch of claim 1 wherein the hook portion is elastically deformable.

5. The pouch of claim 1 wherein the hook portion is planar.

6. The pouch of claim 1 wherein the hook portion comprises a trapezoid.

7. The pouch of claim 6 wherein the trapezoid is an isosceles trapezoid.

8. The pouch of claim 6 wherein a longer base of the trapezoid is nearer to the opening when the pouch is open than a shorter base of the trapezoid.

9. The pouch of claim 8 wherein the longer base of the trapezoid is longer than the slot.

10. The pouch of claim 8 wherein the shorter base of the trapezoid is shorter than the slot.

11. The pouch of claim 1 wherein a portion of the opening uncovered by the flap when the pouch is closed comprises a steam vent that permits steam to escape the interior of the pouch.

12. The cooking pouch of claim 1,
(a) wherein the heat resistant pouch body is manufactured using a material comprising polytetrafluoroethylene, wherein the heat resistant pouch body comprises a slot located in a face of the pouch body and an opening along one side of the pouch body; and
(b) wherein the hook portion is elastically deformable and is insertable through the slot from the interior of the pouch, wherein the hook portion comprises an isosceles trapezoid having a longer base located nearer to where the flap is attached to the pouch body than a shorter base of the trapezoid, wherein the longer base of the trapezoid is longer than the slot and the shorter base of the trapezoid is shorter than the slot.

13.-19. (canceled)

20. The pouch of claim 1, wherein the pouch body comprises bottom, left, and right heat fusion-sealed edges defining the opening in the pouch body.

21. The pouch of claim 1, wherein the pouch body comprises a first side and a second side, wherein one of the first and second sides has a top edge, and wherein a length of the opening is less than a length of the top edge.

22. The pouch of claim 1, wherein the flap portion comprises a further pair of linear edges extending perpendicularly away from the pouch body and connecting the pouch body to the pair of angled linear edges.

23. A closable cooking pouch, the pouch comprising:
(a) a heat resistant pouch body comprising an opening and a slot; and
(b) a flap attached to the pouch body and tuckable into the opening to close the pouch, wherein the flap comprises a hook portion that is insertable through the slot and that is shaped to retain at least a portion of the flap in the slot when the flap is through the slot and the hook portion is outside the pouch, wherein the flap comprises a flap portion connecting the pouch body to the hook portion, wherein the flap comprises a flap portion connecting the pouch body to the hook portion, wherein the flap portion comprises a pair of angled linear edges, wherein the hook portion comprises a pair of lower edges each being parallel to the slot, and wherein each lower edge forms a notch with a respective one of the angled linear edges.

24. A closable cooking pouch, the pouch comprising:
(a) a heat resistant pouch body comprising at least one sealed edge defining an opening in the pouch body, wherein the at least one edge is sealed by ultrasonic welding or by a heat-resistant adhesive, and wherein the pouch body further comprises a slot; and
(b) a flap attached to the pouch body and tuckable into the opening to close the pouch, wherein the flap comprises a hook portion that is insertable through the slot and that is shaped to retain at least a portion of the flap in the slot when the flap is through the slot and the hook portion is outside the pouch, wherein the flap comprises a flap portion connecting the pouch body to the hook portion, wherein the flap portion comprises a pair of angled linear edges, wherein the hook portion comprises a pair of lower edges each being parallel to the slot, and wherein each lower edge forms a notch with a respective one of the angled linear edges.
